(19) United States
(12) Patent Application Publication
(10) Pub. No.: US 2011/0241430 A1
(43) Pub. Date: Oct. 6, 2011

(54) METHOD FOR CONTROLLING SYSTEM GAIN OF UPS

(75) Inventors: Fang Liu, Xi'an (CN); Zhongjun Wei, Xi'an (CN); Xiaoyu MI, Xi'an (CN); Xunbin Wu, Xi'an (CN)

(73) Assignee: LIEBERT CORPORATION, Columbus, OH (US)

(21) Appl. No.: 13/080,341

(22) Filed: Apr. 5, 2011

(30) Foreign Application Priority Data
Apr. 6, 2010 (CN) 201010162238.6

(51) Int. Cl. H02J 9/00

(52) U.S. Cl. 307/66

(57) ABSTRACT

The present invention discloses a control method for the system gain of a UPS, which includes the steps of: S1: detecting a PFC unit so as to determine whether to start an LLC, and if so, then going to step S2; otherwise, going to step S8; S2: starting the LLC; S3: detecting the mains supply so as to determine whether to switch from the mains supply to a battery, and if so, then going to step S4; otherwise, going to step S5; S4: performing a frequency-fixed adjustment on the LLC with an operating frequency larger than a resonating frequency by a preset magnitude while clearing an integral quantity within a first preset time T1; and performing a frequency-fixed adjustment on the LLC with an operating frequency equal to the resonating frequency while clearing the integral quantity between the first preset time T1 and a second preset time T2, and going to step S8; S5: determining whether the LLC-in-series resonant converter has an overload, and if so, then going to step S6; otherwise, going to step S7; S6: performing a frequency-fixed adjustment on the LLC-in-series resonant converter with the operating frequency equal to the resonating frequency while clearing the integral quantity; and going to the step S8; S7: performing a normal PI adjustment on the LLC-in-series resonant converter; and S8: Ending. The operation condition of the PFC is detected in real time, the LLC is started when the PFC becomes abnormal, and the LLC is adjusted in response to a load during operating so that the system gain is maintained in a monotonously step-down region of a ZVS region.

### FIELD OF THE INVENTION

The present invention relates to the control of a system gain, and more specifically to a method for controlling the system gain of a UPS.

### BACKGROUND OF THE INVENTION

Extensive researches have been done on and wide attention has been paid to a resonant converter in applications to the technology of switched power source due to its advantages of high power, high efficiency, high density of power, etc. As a special circuit topology, an LLC-in-series resonant conversion circuit can both satisfy a requirement of high frequency and achieve relatively high conversion efficiency, and thus has been adopted widely in the art. The LLC-in-series resonant conversion circuit commonly used for engineering is generally used in a voltage step-down scenario and has been applied with comparative maturity.

The LLC-in-series resonant converter has characteristics of a wide input voltage range and a wide output power range. However, an important characteristic of the resonant converter in application to the UPS is an interrupted output and thus it is necessary for the resonant converter to have a much wider output power range in this industrial application. Thereby, the adaptability of a monotonous operation range of the LLC-in-series resonant converter to a wide range during operating is still a significant challenge.

A gain curve of an LLC as illustrated in FIG. 2 has two resonant points and the variational trend of a voltage gain is asynchronous with the change of a load and the change of an input voltage. Especially when the load is heavier and the input voltage is lower, the gain curve tends to go into a Zero Current Switching (ZCS) region which is unacceptable for normal operation of the system.

### SUMMARY OF THE INVENTION

A technical problem to be addressed by the present invention is to provide a method for controlling the system gain in view of a drawback of a resonant converter in the prior art, i.e., a gain thereof may transit from a Zero Voltage Switching (ZVS) region to a Zero Current Switching (ZCS) region, and so on.

A technical solution designed for addressing the technical problem according to one aspect of the present invention is to provide a system gain control method used to adjust a resonant converter for monotonicity, comprising:

a determination step for determining whether to switch from the mains supply to a battery by detecting the mains supply; and

an adjustment step for performing a frequency-fixed adjustment on the resonant converter with an operating frequency larger than a resonating frequency by a preset magnitude and clearing an integral quantity within a first preset time T1 in case that switching from the mains supply to a battery is determined to be performed.

In an embodiment, the adjustment step further comprises performing a frequency-fixed adjustment on the resonant converter with an operating frequency equal to the resonating frequency and clearing the integral quantity between the first preset time T1 and a second preset time T2.

In an embodiment, the resonant converter is subjected to the frequency-fixed adjustment with the operating frequency larger than the resonating frequency by 15 kHz in the adjustment step.

In an embodiment, the resonant converter includes a LLC-in-series resonant converter.

In an embodiment, the control method further comprises a start step before the determination step, for determining whether to start the resonant converter by detecting a PFC unit and starting the resonant converter in case that start of the resonant converter is determined to be performed.

In an embodiment, the control method is used for controlling the system gain of a UPS.

In an embodiment, the first preset time T1 ranges from 10 to 20 ms and the second preset time T2 ranges from 30 to 40 ms.

According to another aspect of the present invention, there is provided a system gain control method used to adjust a resonant converter for monotonicity, comprising:

a determination step for determining whether the resonant converter has an overload in the case where the mains supply and a battery provide power jointly or in the case where the battery provides power; and

an adjustment step for performing a frequency-fixed adjustment on the resonant converter with an operating frequency larger than or equal to a resonating frequency and clearing an integral quantity in case that the resonant converter has the overload.

In an embodiment, the control method further comprises a step of performing a normal PI adjustment on the resonant converter in case that the resonant converter does not have the overload.

In an embodiment, the resonant converter includes a LLC-in-series resonant converter.

In an embodiment, the overload comprises one of a high voltage overload and a low voltage overload.

According to a further aspect of the present invention, there is provided a system gain control device configured to adjust a resonant converter for monotonicity, comprising:

a determination unit configured to determine whether to switch from the mains supply to a battery by detecting the mains supply; and

an adjustment unit configured to perform a frequency-fixed adjustment on the resonant converter with an operating frequency larger than a resonating frequency by a preset magnitude and clear an integral quantity within a first preset time T1 in case that switching from the mains supply to a battery is determined to be performed.

In an embodiment, the adjustment unit is further configured to perform a frequency-fixed adjustment on the resonant converter with an operating frequency equal to the resonating frequency and clear the integral quantity between the first preset time T1 and a second preset time T2.

In an embodiment, the resonant converter includes a LLC-in-series resonant converter.

In an embodiment, the control device further comprising a start unit configured to determine whether to start the resonant converter by detecting a PFC unit before the detection of the mains supply and start the resonant converter in case that start of the resonant converter is determined to be performed.

According to a still further aspect of the present invention, there is provided system gain control device configured to adjust a resonant converter for monotonicity, comprising:

a determination unit configured to determine whether the resonant converter has an overload in the case where the mains supply and a battery provide power jointly or in the case where the battery provides power; and

an adjustment unit configured to perform a frequency-fixed adjustment on the resonant converter with an operating frequency larger than or equal to a resonating frequency and clear an integral quantity in case that the resonant converter has the overload.

In an embodiment, the control device further comprises a PI adjustment unit configured to perform a normal PI adjustment on the resonant converter in case that the resonant converter does not have the overload.

In an embodiment, the resonant converter includes a LLC-in-series resonant converter.

According to a still further aspect of the present invention, there is provided a program product stored with a machine-readable instruction code, when said instruction code is read and executed by a machine, the method according to the present invention can be executed.

According to a still further aspect of the present invention, there is provided a storage medium carrying the program product.

The following advantageous effects can be obtained by implementing the control method for the system gain of the UPS according to the invention: the operation condition of the PFC is detected in real time during operation of the UPS, the LLC-in-series resonant converter is started when the PFC becomes abnormal, and the load condition of the LLC-in-series resonant converter is detected in real time and the LLC-in-series resonant converter is adjusted in response to the load during operating so that the system gain is maintained in a monotonously step-down region of a ZVS region.

### BRIEF DESCRIPTION OF THE DRAWINGS

The present invention will be further described below with reference to the drawings and embodiments. In the drawings:

FIG. 1 is a systematic block diagram of a UPS according to the invention;

FIG. 2 is a structural schematic graph illustrating a gain curve of an LLC illustrated in FIG. 1; and

FIG. 3 is a flow chart illustrating a method for controlling the system gain of a UPS according to the invention.

### DETAILED DESCRIPTION OF THE INVENTION

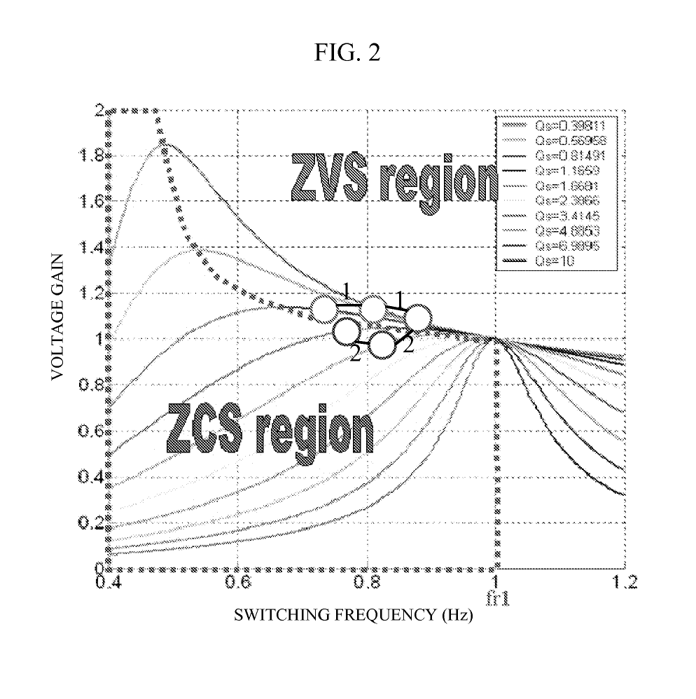

For an LLC-in-series resonant converter under the control of a single voltage loop, a Proportional Integration (PI) controller itself strictly demands for monotonicity. An original negative feedback will change to a positive feedback once an output is controlled to transit into a non-monotonous region of a gain curve, thus resulting in a thorough breakdown of the output, that is, the output on a bus bar will be continuously drawn to breakdown until an outage. However, the manner to transit into the non-monotonous region of the gain curve for an operation point of the LLC-in-series resonant converter is not unique. Taking an output with an overload as an example, the operation point may follow a course denoted by ‘1’ in FIG. 2 in the case of increasing the weight of the load gradually or may follow a course denoted by ‘2’ in FIG. 2 in the case of increasing the weight of the load sharply to be overloaded while transiting from a dynamic status to a steady status, so the two different loading manners lead to two opposite outcomes. An inventive point of the invention is that on the basis of a rated operation point of the gain curve of the LLC-in-series resonant converter, a series of limiting conditions around the rated operation point is set according to different load status so that the operation point will not go beyond a monotonous range.

Firstly, the heavy-load operation circumstances for operation of the LLC-in-series resonant converter shall be ascertained. For a UPS, a function of the LLC-in-series resonant converter is to maintain an output in the case that the mains supply can not operate normally, so an operation circumstance of switching from the mains supply to a battery is equivalent to an instantaneous heavy load for the LLC-in-series resonant converter. Furthermore, the voltage of the battery will step down after the switching to the battery side, and if an overload appears at this time, the LLC-in-series resonant converter tends to go into a non-monotonous region. Finally, there will be a larger dynamic load if loading the overload sharply or removing the overload sharply when it is at the battery side.

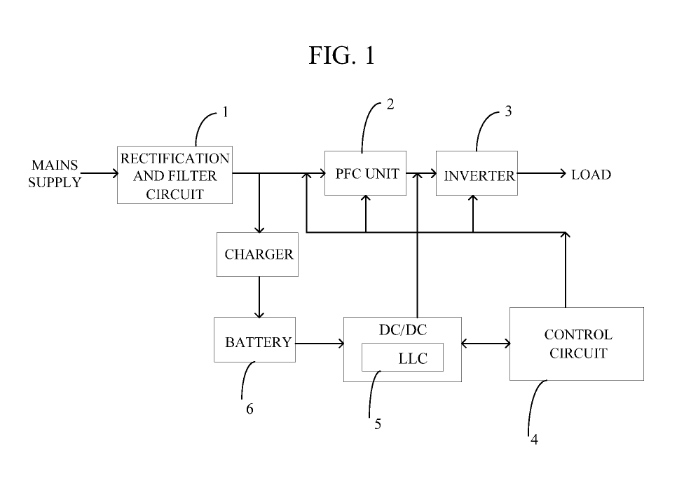

As illustrated in FIG. 1, the mains supply powers an inverter 3 through a PFC unit 2 after being processed by a rectification and filter circuit 1 during normal operation of a UPS according to the present invention. During operation of the UPS, a control circuit 4 detects the operation status of the PFC in real time. When the PFC unit becomes abnormal, the control circuit 4 detects whether an LLC-in-series resonant converter 5 starts to operate, that is, whether it is operative. If the LLC-in-series resonant converter 5 has not operated, then the control circuit 4 will perform a soft startup on it to make it go into a stable operation status. If the LLC-in-series resonant converter 5 is operative, then the control circuit 4 will detect the mains supply, e.g., the voltage, current, amplitude, load, etc., thereof so as to determine whether the mains supply can supply power normally. If there is no abnormality in the mains supply, then it is determined that the mains supply can operate normally. In this case, the mains supply and a battery 6 power the inverter 3 jointly, and during the joint operation of the mains supply and the battery 6 for the inverter 3, the LLC-in-series resonant converter 5 is detected in real time for an overload, i.e., a high voltage overload or a low voltage overload. The control circuit 4 will perform a frequency-fixed adjustment on the LLC-in-series resonant converter 5 with an operating frequency while clearing an integral quantity if the LLC-in-series resonant converter 5 is overloaded, the operating frequency preferably being equal to a resonating frequency fr1 of the LLC-in-series resonant converter 5, alternatively, being larger than the resonating frequency fr1 of the LLC-in-series resonant converter 5; and will perform a normal PI adjustment on the LLC-in-series resonant converter 5 if the LLC-in-series resonant converter 5 is not overloaded. When the mains supply becomes abnormal, switching from the mains supply to the battery 6, which in turn powers the inverter 3 is performed, and this process can be divided into two phases: the first phase is a switching process and the second phase is a switching completion process, where the switching process is timed from start of switching from the mains supply to the battery 6 until a first preset time T1 comes, in which T1 shall take a value to ensure less stresses of resonant current and voltage; and the switching completion process starts with the first preset time T until a second preset time T2 comes, in which T2 shall take a value to ensure continuity of the switching process. In a preferred embodiment, T1 ranges from 10 to 20 ms, and T2 ranges from 30 to 40 ms. During a specific operation, the control circuit 4 will perform a frequency-fixed adjustment on the LLC-in-series resonant converter 5 with an operating frequency larger than the resonating frequency of the LLC-in-series resonant converter 5 while clearing an integral quantity in the first phase and perform a normal PI adjustment on the LLC-in-series resonant converter 5 in the second phase. Thus, the system gain of the UPS can be only monotonously decreased in a ZVS region by the above controls.

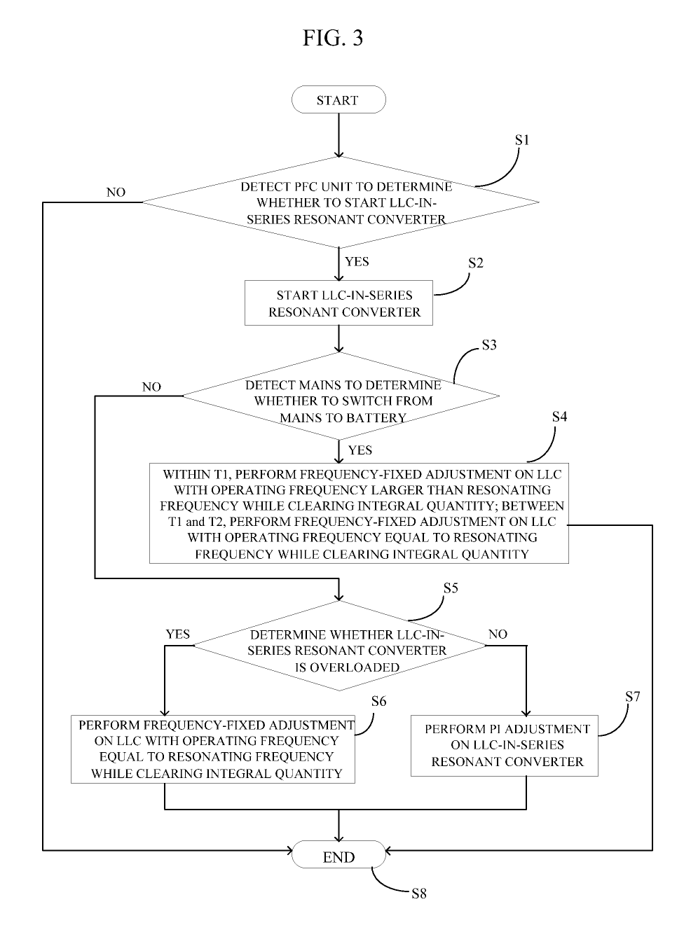

As illustrated in FIG. 3, specific operational steps thereof are as follows:

S1: The PFC unit 2 is detected so as to determine whether to start the LLC-in-series resonant converter 5, and if so, then the flow goes to step S2; otherwise, the flow goes to step S8;

The LLC-in-series resonant converter 5 is started by taking primarily the case where the system (mainly the voltage on the bus bar) is in a relatively severe condition (i.e., the system is heavily loaded) prior to switching from the mains supply to the battery 6 into consideration. In case no special process (other than PI adjustment) is performed on a drive circuit of the LLC-in-series resonant converter 5 after switching to the side of the battery 6, then the LLC-in-series resonant converter 5 will be in a very severe status (the LLC is heavily loaded), thus possibly leading to some device thereof being damaged. General startup conditions are the following two ones:

1. When the PFC fails, for example, the PFC can not operate normally due to disconnection of a hardware circuit or other reason, and the voltage on the bus bar is lower, the LLC-in-series resonant converter can be started; and

2. The current voltage of the mains supply is insufficient to afford the current load, and in this case, the PFC has no capability to further maintain operation of the bus bar, so the LLC-in-series resonant converter 5 can be started.

S2: Starting the LLC-in-series resonant converter 5, which can particularly include:

S21: It is determined whether the LLC-in-series resonant converter 5 is operative, and if so, then the flow goes to step S3; otherwise, the flow goes to step S22; and

S22: Soft startup is performed on the LLC-in-series resonant converter 5.

The mains supply and the LLC-in-series resonant converter 5 power the inverter jointly after the LLC-in-series resonant converter is started;

S3: While the mains supply and the LLC-in-series resonant converter power the inverter jointly, the mains supply is detected in real time, so that the frequency and the valid voltage magnitude of the mains supply are computed and the power of the load and the valid voltage magnitude on the bus bar are derived by sampling the voltage and current of the mains supply, the voltage and current of the inverter and the voltage on the bus bar. Thereby, it is detected whether the mains supply is in a normal or abnormal operation status. Based on this, it is determined whether to switch from the mains supply to the battery, and if so, then the flow goes to step S4; otherwise, the flow goes to step S5;

In the case that the mains supply is overloaded in a fundamental vibration band, there is a significant ripple of the voltage on the bus bar when the mains supply operates with fundamental vibration and an instantaneous magnitude of the voltage on the bus bar may be very low. In this case, switching from the mains supply to the battery can be done.

S4: From start of timing till the first preset time T1, the LLC-in-series resonant converter is subjected to a frequency-fixed adjustment with an operating frequency larger than the resonating frequency by a preset magnitude while the integral quantity is cleared, in which the operating frequency is larger than the resonating frequency by 15 kHz in a preferred embodiment; when the first preset time T1 comes, the LLC-in-series resonant converter is subjected to a frequency-fixed adjustment with a operating frequency equal to the resonating frequency while the integral quantity is cleared until the second preset time T2 comes; and then the flow goes to step S8. A condition necessary for a frequency-fixed adjustment in the case of switching from the mains supply to the battery is that the voltage on the bus bar is lower, so the frequency-fixed adjustment will be required for any operating circumstance in need of switching to the side of the battery when the voltage on the bus bar is lower.

The frequency-fixed adjustment after switching from the mains supply to the battery is as follows:

1. The frequency-fixed adjustment after switching to the side of the battery shall be performed at least for a sufficient period of time so as to ensure operation of the LLC-in-series resonant converter in a monotonous region.

2. After switched to the battery, the system is at the side of the battery, and thus the status of switching from the mains supply to the battery will be transformed into a status of purely battery side. In view of this, a period of time that takes to become operative completely at the side of the battery shall be considered;

2.1. The period of time shall be ensured to be not too long; otherwise, the output of the LLC-in-series resonant converter will be inadaptable to switching of the load; and

2.2. The period of time can not be too short either; otherwise, switching of the status will result in discontinuity of the resonant current of the LLC-in-series resonant converter and the voltage output of bus bar.

In an embodiment, it is determined whether the LLC-in-series resonant converter has an overload in the case where the system operates at the side of the battery. In case that the LLC-in-series resonant converter has an overload, a frequency-fixed adjustment is subjected to the resonant converter with an operating frequency and an integral quantity is cleared. The operating frequency is preferably equal to the resonating frequency. Alternatively, operating frequency is larger than the resonating frequency. Then, the flow goes to step S8.

S5. It is determined whether the LLC-in-series resonant converter is overloaded, and if so, then the flow goes to step S6; otherwise, the flow goes to step S7;

S6. The LLC-in-series resonant converter is subjected to a frequency-fixed adjustment with an operating frequency while the integral quantity is cleared, the operating frequency preferably being equal to the resonating frequency, alternatively, being larger than resonating frequency, and then the flow goes to step S8;

S7. Normal PI adjusting is performed on the LLC-in-series resonant converter; and

S8. The flow ends.

The invention has been described in connection with several embodiments thereof, and those skilled in the art shall appreciate that various changes and equivalent substitutions can also be made to the invention. Furthermore, the invention can be modified variously for a specific scenario or a particular situation without departing from the scope of the invention. Accordingly, the invention will not be limited to the disclosed embodiments but shall encompass any embodiments falling into the scope of the invention defined by the claims.

1. A system gain control method used to adjust a resonant converter for monotonicity, comprising:
a determination step for determining whether to switch from the mains supply to a battery by detecting the mains supply; and
an adjustment step for performing a frequency-fixed adjustment on the resonant converter with an operating frequency larger than a resonating frequency by a preset magnitude and clearing an integral quantity within a first preset time T1 in case that switching from the mains supply to a battery is determined to be performed.

2. The system gain control method according to claim 1, the adjustment step further comprises performing a frequency-fixed adjustment on the resonant converter with an operating frequency equal to the resonating frequency and clearing the integral quantity between the first preset time T1 and a second preset time T2.

3. The system gain control method according to claim 1, wherein the resonant converter is subjected to the frequency-fixed adjustment with the operating frequency larger than the resonating frequency by 15 kHz in the adjustment step.

4. The system gain control method according to claim 1, wherein the resonant converter includes a LLC-in-series resonant converter.

5. The system gain control method according to claim 1, further comprising a start step before the determination step, for determining whether to start the resonant converter by detecting a PFC unit and starting the resonant converter in case that start of the resonant converter is determined to be performed;

6. The system gain control method according to claim 1, wherein the control method is used for controlling the system gain of a UPS.

7. The system gain control method according to claim 2, wherein the first preset time T1 ranges from 10 to 20 ms and the second preset time T2 ranges from 30 to 40 ms.

8. A system gain control method used to adjust a resonant converter for monotonicity, comprising:
a determination step for determining whether the resonant converter has an overload in the case where the mains supply and a battery provide power jointly or in the case where the battery provides power; and
an adjustment step for performing a frequency-fixed adjustment on the resonant converter with an operating frequency larger than or equal to a resonating frequency and clearing an integral quantity in case that the resonant converter has the overload.

9. The system gain control method according to claim 8, further comprising a step of performing a normal PI adjustment on the resonant converter in case that the resonant converter does not have the overload.

10. The system gain control method according to claim 8, wherein the resonant converter includes a LLC-in-series resonant converter.

11. The system gain control method according to claim 8, wherein the overload comprises one of a high voltage overload and a low voltage overload.

12. A system gain control device configured to adjust a resonant converter for monotonicity, comprising:
a determination unit configured to determine whether to switch from the mains supply to a battery by detecting the mains supply; and
an adjustment unit configured to perform a frequency-fixed adjustment on the resonant converter with an operating frequency larger than a resonating frequency by a preset magnitude and clear an integral quantity within a first preset time T1 in case that switching from the mains supply to a battery is determined to be performed.

13. The system gain control device according to claim 12, the adjustment unit is further configured to perform a frequency-fixed adjustment on the resonant converter with an operating frequency equal to the resonating frequency and clear the integral quantity between the first preset time T1 and a second preset time T2.

14. The system gain control device according to claim 12, wherein the resonant converter includes a LLC-in-series resonant converter.

15. The system gain control device according to claim 12, further comprising a start unit configured to determine whether to start the resonant converter by detecting a PFC unit before the detection of the mains supply and start the resonant converter in case that start of the resonant converter is determined to be performed;

16. A system gain control device configured to adjust a resonant converter for monotonicity, comprising:
a determination unit configured to determine whether the resonant converter has an overload in the case where the mains supply and a battery provide power jointly or in the case where the battery provides power;
an adjustment unit configured to perform a frequency-fixed adjustment on the resonant converter with an operating frequency larger than or equal to a resonating frequency and clear an integral quantity in case that the resonant converter has the overload.

17. The system gain control device according to claim 16, further comprising a PI adjustment unit configured to perform a normal PI adjustment on the resonant converter in case that the resonant converter does not have the overload.

18. The system gain control device according to claim 16, wherein the resonant converter includes a LLC-in-series resonant converter.

19. A program product stored with a machine-readable instruction code,
when said instruction code is read and executed by a machine, the method according to any of claims 1-12 can be executed.

20. A storage medium carrying the program product according to claim 19.
